(19) United States
(12) Patent Application Publication
(10) Pub. No.: US 2025/0315410 A1
(43) Pub. Date: Oct. 9, 2025

(54) ATTRIBUTE UPDATING METHOD AND APPARATUS FOR DIRECTORY IN DISTRIBUTED FILE SYSTEM, DEVICE AND STORAGE MEDIUM

(71) Applicant: Beijing Baidu Netcom Science Technology Co., Ltd., Beijing (CN)

(72) Inventors: Biao CAO, Beijing (CN); Jielong JIAN, Beijing (CN); Qiushi CHEN, Beijing (CN); Liguo DUAN, Beijing (CN); Ran ZHENG, Beijing (CN)

(21) Appl. No.: 19/238,609

(22) Filed: Jun. 16, 2025

(30) Foreign Application Priority Data
Dec. 20, 2024 (CN) 202411897610.6

(51) Int. Cl. G06F 16/182; G06F 16/17; G06F 16/176

(52) U.S. Cl. CPC G06F 16/1824; G06F 16/1734; G06F 16/1767

(57) ABSTRACT

The present disclosure provides an attribute updating method and apparatus for a directory in a distributed file system, a device and a storage medium, which relates to the field of computer technology and, in particular, to the field of big data and distributed file systems. A specific implementation solution is as follows: firstly, it can be determined whether the distributed system needs to update the attribute file of a certain directory through an incremental table. If it is required to update the attribute file of this directory through the incremental table, the update information required for updating the attribute file of the directory using the incremental table can be further determined. Further, the update information can be written into the increment table.

### CROSS-REFERENCE TO RELATED APPLICATION

The present application claims priority to Chinese Application No. 202411897610.6, filed on Dec. 20, 2024, which is hereby incorporated by reference in its entirety.

### TECHNICAL FIELD

The present disclosure relates to big data and distributed file systems in computer technology and, in particular, to an attribute updating method and apparatus for a directory in a distributed file system, a device and a storage medium.

### BACKGROUND

With the increasing volume of data, distributed file systems are being applied more extensively. During the operation of the distributed file systems, concurrent operations on subdirectories under a same directory often occur. After performing operations on the subdirectories under the directory, the attribute file of the directory typically needs to be updated. To avoid conflicts when reading from and/or writing to the attribute file of the directory, currently, queuing and serialization processing is usually performed on operations of subdirectories under the same directory.

However, this queuing and serialization processing tends to cause low throughput issues during operations on subdirectories under the same directory in a distributed file system.

### SUMMARY

The present disclosure provides an attribute updating method and apparatus for a directory in a distributed file system, a device and a storage medium.

According to a first aspect of the present disclosure, an attribute updating method for a directory in a distributed file system is provided, the method including:
when it is determined that attribute information in an attribute file of the directory in the distributed system needs to be updated, determining update information for the attribute file of the directory, and writing the update information into a preset incremental table; where the distributed system includes a plurality of directories, and the plurality of directories have a parent-child relationship; the update information indicates a modification content for the attribute file of the directory;
updating the attribute file of the directory corresponding to the update information by using the update information in the preset incremental table in response to a merge instruction; where the merge instruction indicates to update the attribute file of the corresponding directory by using the update information in the preset incremental table.

According to a second aspect of the present disclosure, an attribute updating apparatus for a directory in a distributed file system is provided, including:
an increment unit, configured to, when it is determined that attribute information in an attribute file of the directory in the distributed system needs to be updated, determine update information for the attribute file of the directory, and write the update information into a preset incremental table; where the distributed system includes a plurality of directories, and the plurality of directories have a parent-child relationship, and the update information indicates a modification content for the attribute file of the directory;
an update unit, configured to update the attribute file of the directory corresponding to the update information by using the update information in the preset incremental table in response to a merge instruction, where the merge instruction indicates to update the attribute file of the corresponding directory by using the update information in the preset incremental table.

According to a third aspect of the present disclosure, an electronic device is provided, including:
at least one processor; and a memory communicatively connected to the at least one processor; where the memory stores instructions executable by the at least one processor, and the instructions are executed by the at least one processor to enable the at least one processor to implement the method of the first aspect.

According to a fourth aspect of the present disclosure, a non-transitory computer-readable storage medium storing computer instructions is provided, where the computer instructions are used to cause a computer to perform the method according to the first aspect.

According to a fifth aspect of the present disclosure, a computer program product is provided, the computer program product including a computer program, the computer program is stored in a readable storage medium and at least one processor of an electronic device can read the computer program from the readable storage medium, and the at least one processor executes the computer program to cause the electronic device to perform the method according to the first aspect.

It should be understood that what is described in this section is not intended to identify key or important features of the embodiments of the disclosure, nor is it intended to limit the scope of the present disclosure. Other features of the present disclosure will be readily understood from the following description.

### BRIEF DESCRIPTION OF DRAWINGS

The attached drawings are used for a better understanding of this solution and do not constitute a limitation of the present disclosure. Among them:

FIG. 1 is a schematic diagram of a first embodiment according to the present disclosure.

FIG. 2 is a schematic diagram of a second embodiment according to the present disclosure.

FIG. 3 is a schematic diagram of a third embodiment according to the present disclosure.

FIG. 4 is a schematic diagram of a fourth embodiment according to the present disclosure.

FIG. 5 is a schematic diagram of a fifth embodiment according to the present disclosure.

FIG. 6 is a schematic block diagram of an electronic device for implementing an embodiment of the present disclosure.

FIG. 7 is a scene diagram of a distributed file system where embodiments of the present disclosure can be implemented.

### DESCRIPTION OF EMBODIMENTS

Exemplary embodiments of the present disclosure are described below with reference to the accompanying drawings, which include various details of the embodiments of the present disclosure to facilitate understanding, and they should be considered as exemplary only. Therefore, those skilled in the art should realize that various changes and modifications can be made to the embodiments described herein without departing from the scope and spirit of the present disclosure. Also, for the sake of clarity and conciseness, descriptions of well-known functions and structures are omitted in the following description.

With the increasing volume of data, distributed file systems are being applied more and more extensively. In order to speed up path resolution in distributed file systems, the prior art introduces a tree-shaped menu component (Dtree) into distributed file systems to speed up the path resolution. However, with the addition of Dtree, the complexity of operations in distributed file systems increases. In a distributed file system with Dtree, both Dtree and directory entry (Dentry) need to be updated in response to an operation executed by an operation request. This operation across the Dtree and Dentry is a two-phase commit (2PC) transaction.

When a user's operation request is for performing an operation on a subdirectory under a directory, the update of Dentry is to update the attribute file of the directory. At this time, the execution of a 2PC transaction will increase the possibility of transaction conflicts when updating the attribute file of this directory. Especially, in the case of concurrent operations on subdirectories under the same directory, the 2PC transaction requires reading the attribute file of the directory frequently, which will further increase the possibility of transaction conflicts. Among them, the operations can include creating a subdirectory under the directory, deleting a subdirectory, modifying the name of a subdirectory, modifying the permissions of a subdirectory, and so on.

At present, transaction conflicts are mainly avoided by queuing and serially processing concurrent operations on subdirectories under the same directory. However, with the approach of queuing and serial processing of operation requests, the queries-per-second (QPS) of the directory's throughput for operation requests can only be maintained at a level of several hundreds, making it difficult to meet the performance requirements of a high concurrency scenario.

In order to solve the above problems, the present disclosure proposes an attribute updating method for a directory in a distributed file system, which can update the attribute file of the directory based on incremental (Delta) updating, thus avoiding transaction conflicts caused by frequent reading and/or writing of the attribute file of the directory in the case of high-concurrency operations on subdirectories under the same directory. The Delta updating can store the update information of metadata in the attribute file of the directory through a delta record, instead of directly updating the metadata by reading from and/or writing to the attribute file of the directory. Delta records can actually exist in the form of an incremental table. By regularly merging and updating the update information accumulated in the incremental table into the attribute file of a corresponding directory, asynchronous update of the attribute file is realized. At the same time, the merged update information in the incremental table is deleted to reduce data redundancy and scanning burdens.

In addition, in view of the fact that the existence of the delta records will require scanning delta records to compute a correct result when accessing the attribute file, in order to balance performance and accuracy, the present disclosure can enable the delta records on demand. That is, Delta records are enabled only when high-frequency contention persists within the directory, so as to avoid unnecessary overhead.

By enabling Delta records, the present disclosure avoids possible conflicts in the process of reading from and writing to the attribute file of the directory when the 2PC transaction of the distributed file system is executed, significantly enhancing the concurrent processing capability for operations on subdirectories under the same directory and greatly improving the operation throughput of the distributed file system. Moreover, the mechanism of enabling delta recording on demand allows the system to dynamically adjust according to the actual contention situation and adapt to different scenarios, further improving the overall performance of the distributed file system.

The present disclosure provides an attribute updating method and apparatus for a directory in a distributed file system, a device and a storage medium, which are applied to big data and distributed file systems in computer technology, so as to achieve the effect of improving the throughput of operations on subdirectories under a same directory.

It should be noted that the data in the embodiments is not targeted at a specific user and cannot reflect personal information of a specific user. It should be noted that the data in the embodiments comes from public data sets.

In the technical solution of the present disclosure, the collection, storage, usage, processing, transmission, provision and disclosure of personal information of users are all in compliance with the provisions of relevant laws and regulations, and do not violate public order and good morals.

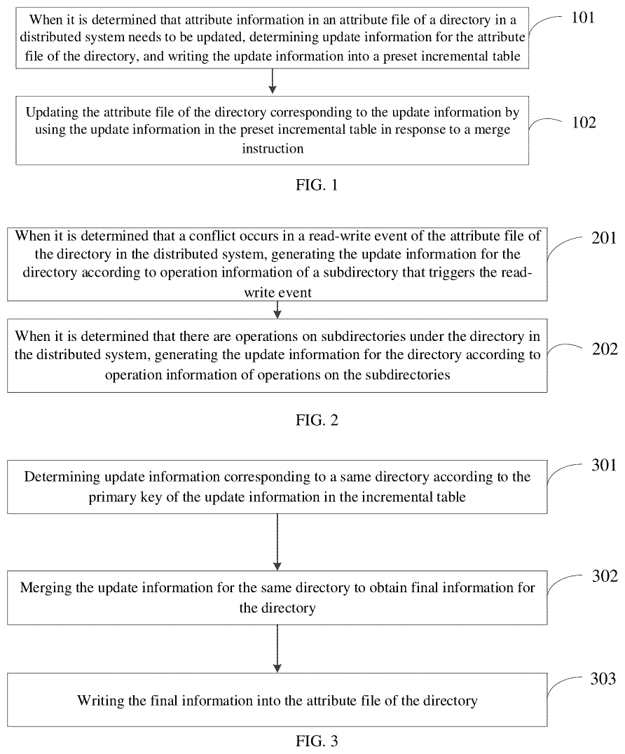

In order to make readers understand the implementation principle of the present disclosure more deeply, the embodiment shown in FIG. 1 is further refined in combination with the following FIG. 2 to FIG. 4.

FIG. 1 is a schematic diagram of a first embodiment according to the present disclosure. As shown in FIG. 1, the present disclosure provides an attribute updating method for a directory in a distributed file system, which includes the following steps.

101, when it is determined that attribute information in an attribute file of a directory in a distributed system needs to be updated, determining update information for the attribute file of the directory, and writing the update information into a preset incremental table. Among them, the distributed system includes multiple directories, and there is a parent-child relationship between the multiple directories. The update information indicates a modification content for the attribute file of the directory.

This embodiment is applied to a distributed file system. The distributed file system may have a tree-shaped directory structure. There can be a parent-child relationship between the directories in the tree-shaped directory structure. Firstly, it can be determined whether the distributed system needs to update the attribute file of a certain directory through an incremental table. If it is needed to update the attribute file of the directory through the incremental table, the update information required for updating the attribute file of this directory using the incremental table can be further determined. Furthermore, the update information can be written into the incremental table to update the attribute file of the directory using the incremental table. The update information is used to indicate the modification content for the attribute file of the directory. In an embodiment, the increment table can be as shown in Table 1.

TABLE 1

| Directory | | Subdirectory | | Change in the | |
|---|---|---|---|---|---|
| serial | | serial | | number of | |
| number | Name | number | Type | subdirectories | . . . |
| 12 | /_ATTR1 | | | +3 | . . . |
| 12 | /_ATTR1$TS1 | | | +1 | . . . |
| 12 | /_ATTR1$TS2 | | | −1 | . . . |
| 12 | bar | 21 | dir | | . . . |
| 12 | baz | 22 | dir | | . . . |

As shown in Table 1, the increment table may include multiple fields. Among them, the fields such as directory serial number, name, subdirectory serial number and type are used to indicate the information of a directory or a subdirectory, and the fields such as the change in the number of subdirectories are used to indicate the modification content for the attribute file of the directory. In an embodiment, in addition to the change in the number of subdirectories (links) already exemplified in Table 1, the table may also include directory size (size), permissions, last modified time of file content (mtime), last modified time of file permissions (ctime) and so on. Among them, the primary key of the incremental table can be set to (pid, ATTR$ts). Pid is the directory serial number. ATTR is the name. This name can be the name of the attribute file. Ts is a timestamp. The timestamp is a time stamp when an update information entry is generated. Alternatively, the timestamp may be a timestamp corresponding to the acquisition time of the operation request. $ is a connector between ATTR and ts. In an embodiment, the connector may also be replaced by other symbols such as “+”, “−” and “,” Among them, fields such as the change in the number of subdirectories (links) and directory size (size) can correspond to numerical parameters, and the contents of these fields can be numerical variables such as +1, −1, +3 and −5. The permissions, last modified time of file content (mtime), last modified time of file permissions (ctime) and the like can correspond to non-numerical parameters.

102, updating the attribute file of the directory corresponding to the update information by using the update information in the preset incremental table in response to a merge instruction, where the merge instruction indicates to update the attribute file of the corresponding directory by using the update information in the preset incremental table.

In this embodiment, after the merge instruction is triggered, the update of the attribute files of one or more directories corresponding to the merge instruction can be performed in response to the merge instruction. Specifically, in response to the merge instruction, the update information for the one or more directories can be obtained from the incremental table, and the update information for the one or more directories can be merged per directory. The merged update information can be used to update the attribute file of the directory, thus improving the update efficiency of the attribute file.

In an embodiment, multiple merging processes may be set in the distributed file system. Each merging process can be used to update the attribute files of one or more directories. The merge instruction is used to trigger a task of a merging process for one or more directories. Each task corresponds to a directory. When the task is triggered, the merging processes will merge the update information for the directory corresponding to the task and update the attribute file of the directory.

For example, suppose there is a directory C, and there are five mkdir operations in a high concurrency environment, which are used to create 5 subdirectories D1 to D5 under the directory C respectively. Assuming that a second threshold is 5, then, a concurrent incremental state can be entered. That is, an update information entry is generated for each mkdir operation. Th update information can be written into the incremental table. For example, the update information can be (C_pid, _ATTR_ts1, num+1), (C_pid, _ATTR_ts2, num+1), . . . , (C_pid, ATTR_ts5, num+1). These update information entries act as participants in the 2PC transaction, and the attribute file can be updated after the transaction execution is completed. In a set merging period, the distributed file system can scan the update information in the incremental table, merge and get the information of num+5, and update the information of num+5 to the attribute file of C. These update information entries are deleted to ensure the consistency between the incremental table and the attribute file.

In this embodiment, when it is determined that the attribute file of the directory needs to be updated by using the incremental table, the update information for the attribute file of the directory is determined from the modification content for the attribute file of the directory; the update information is written into a preset incremental table; the update information for the directory indicated by the merge instruction is obtained from the incremental table in response to the merge instruction; the update information for the directory is merged and the merged update information is updated into the attribute file of the directory. In this way, conflicts that may occur when the attribute file of the directory is frequently read and/or written can be avoided, thus improving the processing capacity for concurrent operations on subdirectories under the same directory and improving the throughput of the distributed file system.

On the basis of the embodiment, the trigger conditions of the merge instruction at least include the following two types.

First, a merge instruction for a directory is generated periodically according to a preset period of the directory.

In an embodiment, each directory may correspond to a preset period. For example, the preset period can be once every 1 second, once every 10 seconds, etc. According to the preset period, the merge instruction for the directory can be triggered periodically. In response to the merge instruction, the merge task for the directory can be triggered in a merge process corresponding to the directory.

Second, during the traversal of the incremental table in response to a user request, if it is detected that the amount of update information corresponding to a directory in the incremental table is greater than or equal to a third threshold, a merge instruction for the directory is generated.

In an embodiment, if a user requests to read the file attributes of a directory, then while the file attributes of the directory are read, the incremental table will be traversed to obtain the update information corresponding to the file attributes of the directory in the incremental table. According to the file attributes and the update information, the latest information of the file attributes can be obtained and fed back to the user. In the process of traversing the incremental table, if it is detected that there is a case that the number of update information entries corresponding to the directory is greater than or equal to the third threshold, the merge instruction for the directory can be triggered. In an embodiment, the directory may be a directory that the user requests to read. Or, the directory can also be any directory except the directory that the user requests to read. In response to the merge instruction, the merging task for the directory can be triggered in the merge process corresponding to the directory. In an embodiment, if there are multiple merge tasks to be processed in the merging process, the merging task can be advanced to achieve rapid processing for the update information for the directory in the incremental table.

The generation processes of the above two types of merge instructions are independent of each other.

Through the generation processes of the above two types of merge instructions, on the basis of ensuring periodically processing the update information for the directory, in a case that the update information for a directory is found to be of a particularly large amount, the merge processing thereof is prioritized, so as to improve the processing efficiency of the update information and avoid the reduction of the processing efficiency caused by too much update information for one directory.

FIG. 2 is a schematic diagram of a second embodiment according to the present disclosure. As shown in FIG. 2, the present disclosure provides an attribute updating method for a directory in a distributed file system, which is used to implement the above step 101 of determining the update information for the attribute file of the directory when it is determined that the attribute information in the attribute file of the directory in the distributed system needs to be updated. The method includes the following steps.

201, when it is determined that a conflict occurs in a read-write event of the attribute file of the directory in the distributed system, generating the update information for the directory according to operation information of a subdirectory that triggers the read-write event. The read-write event indicates that the subdirectory requests to read and/or write the attribute file. Operation information indicates information generated by performing an operation on the subdirectory.

In this embodiment, firstly, it can be determined whether a conflict occurs in the read-write event of the attribute file of the directory in the distributed system. If there is a conflict, it means that the attribute file of the directory in the distributed system needs to be updated by means of an incremental table. Further, according to the operation information of the subdirectory that triggers the read-write event, the update information for the attribute file of the directory that needs to be written into the incremental table can be determined. The subdirectory is a subdirectory under the directory. The operation information is information generated when the operation corresponding to the operation request of a user to generate the subdirectory is executed. In this way, conflicts can be resolved during reading and writing processes of the attribute file, so that concurrent operations on subdirectories can be better performed and the throughput of the distributed file system can be improved.

Specifically, the above step 201 can determine the generated update information that needs to be written into the incremental table according to the number of conflicts occurring in the attribute file of the directory within the first time period, or the frequency of conflicts occurring in the attribute file of the directory, and specifically, the following steps could be included.

2011, if the number of conflict occurrences within the first time period is less than or equal to the first threshold, entering a conflict incremental state of the directory, where the conflict incremental state indicates that the update information for the directory is generated according to operation information of a subdirectory corresponding to a read-write event in which a conflict occurs.

In this embodiment, it is possible to count the number of conflict occurrences in the first time period before a current moment. If the number of conflict occurrences is less than or equal to the first threshold, it means that there are a few conflicts. At this point, the conflict incremental state can be entered. In the conflict incremental state, the subdirectory where the conflict occurs can be determined according to the occurred conflict. Furthermore, according to the operation information of the subdirectory, update information for the directory is generated, and the update information is written into the incremental table. This conflict incremental state can reduce the situation of writing to the incremental table under the condition that the reading and/or writing of the attribute file of the directory can be tolerated, and reduce the computational power consumption caused by reading the incremental table when requesting the attribute file.

2012, if the number of conflict occurrences within the first time period is greater than the first threshold, entering a first full incremental state of the directory, where the first full incremental state means that the update information for the directory is generated according to the operation information of all subdirectories that trigger a read-write event of the attribute file.

In this embodiment, if the counted number of conflict occurrences is greater than the first threshold in the first time period before the current moment, it means that there are a lot of conflicts. At this point, the first full incremental state is entered. In this first full incremental state, update information for the directory can be generated from the operation information of all subdirectories under this directory and written into the incremental table. On the one hand, this processing method can avoid additional conflicts when conflicts occur frequently, and avoid further expansion of anomalies after a large number of conflicts appear. On the other hand, frequent conflicts at this time mean that there are a large number of concurrent operations on subdirectories in this directory. This processing method can reduce the computational power consumed by counting the number of conflict occurrences, and apply this computational power to the concurrent operations on the subdirectories.

To sum up, through the above steps 2011 and 2012, restrictions are imposed on converting the operation information of subdirectories into the update information for directory under different conflict frequencies, and the processing efficiency of distributed operating system is flexibly improved.

In an embodiment, after entering the first full incremental state in step 2012, the following steps could also be included.

2013, if no read-write events occur on the attribute file of the directory within the second time period, exiting the first full incremental state of the directory.

In this embodiment, it is possible to record a time duration during which no read-write events occur on the attribute file of the directory. If the time duration reaches a second time period, it means that a period of high-concurrency operations on the subdirectories of the directory has passed. At this point, the first full incremental state of the directory can be exited. Exiting the first full incremental state can prevent generating the update information from operations on subdirectories and writing the update information into the incremental table when there are a small number of operations on the subdirectories. This method can further realize the flexible control over the writing of the incremental table and improve the flexibility and efficiency of updating the attribute file of the directory in the distributed operating system.

202, when it is determined that there are concurrent operations on subdirectories under the directory in the distributed system, generating the update information for the directory according to operation information of the concurrent operations on the subdirectories. Concurrent operations represent operations that are triggered in a same time period. Operation information represents information generated by performing operations on the subdirectories.

In this embodiment, firstly, it can be determined whether there are concurrent operations on subdirectories under the directory in the distributed system. In an embodiment, the concurrent operations can specifically be operations on subdirectories that are triggered in the same time period. When performing an operation on a subdirectory, it is usually required to update the attribute file of the directory according to the operation. Hence, when there are concurrent operations, the attribute file of the directory may be updated in the same time period because of multiple concurrent operations, which may lead to conflicts in updating the attribute file. Therefore, in order to better avoid conflicts, the update information for the directory can be generated according to the operation information of the concurrent operations on the subdirectories. The operation information is information generated when performing an operation on a subdirectory. The operation can specifically include deleting a subdirectory, adding a subdirectory, modifying the name of a subdirectory and the like. In this way, the concurrent operations on subdirectories under the directory can be better optimized to avoid conflicts which occur when the attribute file is updated by these concurrent operations.

Specifically, the above step 202 can determine the generated update information that needs to be written into the incremental table according to the number of concurrent operations on subdirectories under the directory, and specifically, the following steps could be included.

2021, entering a concurrent incremental state of the directory if it is determined that a number of times of concurrent operations on subdirectories under the directory in the distributed system is greater than or equal to a second threshold and less than a third threshold, where the concurrent incremental state indicates that the update information for the directory is generated according to operations, which are concurrent, on the subdirectories under the directory.

In this embodiment, the number of concurrent operations on the subdirectories under this directory can be obtained. If the number is greater than or equal to the second threshold and less than the third threshold, it means that there is a certain amount of concurrency, but not very high. At this point, the concurrent incremental state of the directory is entered. In this concurrent incremental state, the update information for the directory can be generated from operations, which are concurrent, on the subdirectories under the directory and written into the incremental table. At this time, if the concurrent operations on the subdirectories under this directory is performed normally, a few conflicts may be caused in the updating process of the attribute file. Therefore, in order to avoid conflicts, update information can be generated according to the operation information of concurrent operations, thus improving the execution efficiency of the distributed file system for the concurrent operations.

2022, entering a second full incremental state of the directory if it is determined that the number of concurrent operations on subdirectories under the directory in the distributed system is greater than or equal to a third threshold, where the second full incremental state indicates that the update information for the directory is generated according to operations on the subdirectories under the directory.

In this embodiment, if the number of concurrent operations on the subdirectories under the directory is greater than or equal to the third threshold, it means that there are a large number of concurrent operations. At this time, in order to avoid conflicts that may occur during updating the attribute file of the directory when there are a large number of concurrent operations, and further reduce other computing power losses, the second full incremental state is entered. In this second full incremental state, update information can be generated correspondingly from all the operation information of operations on the subdirectories under this directory, and the update information can be written into the incremental table. This processing method can avoid the conflict when updating the attribute file under a high concurrency situation.

To sum up, through the above steps 2021 and 2022, restrictions are imposed on converting the operation information of subdirectories into the update information for the directory under different concurrent quantities, and the processing efficiency of the distributed operating system is flexibly improved.

In an embodiment, after entering the second full incremental state in step 2022, the following steps may be further included.

2023, exiting the second full incremental state of the directory if no operations occur on the subdirectories in the directory for a third time period.

In this implementation, it is possible to record a time duration during which no operations occur on the subdirectories under the directory. If the time duration reaches the third time period, it means that a period of high-concurrency operations on the subdirectories of the directory has passed. At this point, the second full incremental state of the directory is exited. Exiting the second full incremental state can avoid writing the update information generated from the operations performed on the subdirectories into the incremental table when there are a few operations performed on the subdirectories. This method can further realize flexible control over the writing of the incremental table and improve the flexibility and efficiency of updating the attribute file of the directory in the distributed operating system.

In this embodiment, when a conflict occurs in a read-write event of the attribute file, the update information for the directory is generated according to the operation information of the subdirectory that triggers the read-write event, or when it is determined that there are concurrent operations on the subdirectories under the directory, the update information for the directory is generated according to the operation information of the concurrent operations on the subdirectories, so as to realize the control over the generation of the update information and the mechanism of enabling the incremental table on demand, so that the system can be dynamically adjusted according to the actual conflict situation to adapt to different scenarios, and flexibly optimize the overall performance.

FIG. 3 is a schematic diagram of a third embodiment according to the present disclosure. As shown in FIG. 3, the present disclosure provides an attribute updating method for a directory in a distributed file system, which is used to realize the process of updating the attribute file of the directory by using the update information in the preset incremental table in step 102. The method includes the following steps.

301, determining the update information corresponding to a same directory according to a primary key of the update information in the incremental table.

In this embodiment, the increment table can be as shown in Table 1 in the embodiment shown in FIG. 1. In the incremental table, the directory serial number and name can form the primary key of the update information in the incremental table. Because the name contains the name of the attribute file and the timestamp, it can be determined whether the update information corresponds to the same directory according to the directory serial number in the primary key and the name of the attribute file in the Name. If the directory serial number in the primary key and the name of the attribute file in the name of two update information entries are consistent, it means that the two update information entries correspond to the same directory.

302, merging the update information for the same directory to obtain final information for the directory.

In this embodiment, multiple update information entries for the same directory can be merged to obtain the final information for the directory. The merging process can be performed for numerical parameters and non-numerical parameters respectively. In an embodiment, for a numerical parameter, the numerical parameter in multiple updated information entries can be summed to obtain the numerical parameter in the final information. For a non-numerical parameter, the non-numerical parameter in the update information can be iterated according to the timestamp of the update information to obtain the non-numerical parameter in the final information. The timestamp of the update information is the timestamp in the name in the primary key.

For example, the update information with a prefix (C_pid, _ATTR) can be obtained by traversing the incremental table, and it is determined that the update information all corresponds to a directory C. Multiple update information entries corresponding to this directory C can be merged. For a numerical parameter such as links and size, the increment/decrement amounts of the numerical parameter are recorded in the update information. At this point, the increment/decrement amounts of the numerical parameter can be summed to get a final increment/decrement amount. For a non-numerical parameter such as permissions, mtime and ctime, a recorded result is recorded in the update information. At this point, the latest recorded result can be taken as the final result through a simple overwrite operation.

303, writing the final information into the attribute file of the directory.

In this embodiment, after obtaining the final information for the directory, the attribute file of the directory can be updated by using the final information for the directory, thereby achieving merging of the update information for the directory.

In this embodiment, by merging the update information in the incremental table into the attribute file of the directory, attribute file conflicts are avoided, the update of the attribute file is achieved, and the processing efficiency of the distributed file system for subdirectory operations under the directory is improved.

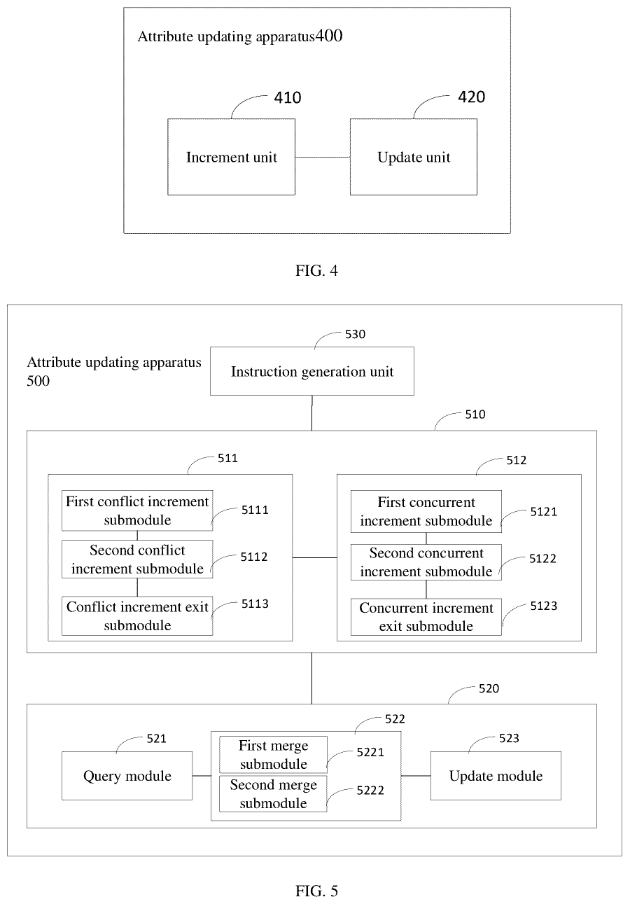

FIG. 4 is a schematic diagram of a fourth embodiment according to the present disclosure. As shown in FIG. 4, the present disclosure provides an attribute updating apparatus 400 for a directory in a distributed file system, including:

an increment unit 410, configured to, when it is determined that attribute information in an attribute file of the directory in the distributed system needs to be updated, determine update information for the attribute file of the directory, and write the update information into a preset incremental table; where the distributed system includes a plurality of directories, and the plurality of directories have a parent-child relationship, and the update information indicates a modification content for the attribute file of the directory;

an update unit 420, configured to update the attribute file of the directory corresponding to the update information by using the update information in the preset incremental table in response to a merge instruction, where the merge instruction indicates to update the attribute file of the corresponding directory by using the update information in the preset incremental table.

The apparatus of this embodiment can implement the technical solution in the above method, and their specific implementation processes and technical principles are the same, which is not repeated here.

FIG. 5 is a schematic diagram of a fifth embodiment according to the present disclosure. As shown in FIG. 5, the present disclosure provides an attribute updating apparatus 500 for a directory in a distributed file system, including:
an increment unit 510, configured to, when it is determined that attribute information in an attribute file of the directory in the distributed system needs to be updated, determine update information for the attribute file of the directory, and write the update information into a preset incremental table; where the distributed system includes a plurality of directories, and the plurality of directories have a parent-child relationship, and the update information indicates a modification content for the attribute file of the directory;
an update unit 520, configured to update the attribute file of the directory corresponding to the update information by using the update information in the preset incremental table in response to a merge instruction, where the merge instruction indicates to update the attribute file of the corresponding directory by using the update information in the preset incremental table.

In an embodiment, the increment unit 510 includes:
a conflict increment module 511, configured to, when it is determined that a conflict occurs in a read-write event of the attribute file of the directory in the distributed system, generate the update information for the directory according to operation information of a subdirectory that triggers the read-write event; where the read-write event indicates that the subdirectory requests to read and/or write the attribute file; the operation information indicates information generated by performing an operation on the subdirectory.

In an embodiment, the conflict increment module 511 includes:
a first conflict increment submodule 5111, configured to enter a conflict incremental state of the directory if a number of conflict occurrences within a first time period is less than or equal to a first threshold, where the conflict incremental state indicates that the update information for the directory is generated according to operation information of a subdirectory corresponding to the read-write event in which a conflict occurs.

In an embodiment, the conflict increment module 511 includes:
a second conflict increment submodule 5112, configured to enter a first full incremental state of the directory if a number of conflict occurrences within a first time period is large than a first threshold, where the first full incremental state indicates that the update information for the directory is generated according to operation information of all subdirectories that trigger the read-write event of the attribute file.

In an embodiment, the conflict increment module 511 includes:
a conflict increment exit submodule 5113, configured to exit the first full incremental state of the directory if no read-write events occur on the attribute file of the directory within a second time period.

In an embodiment, the increment unit 510 includes:
a concurrent increment module 512, configured to, when it is determined that there are concurrent operations on subdirectories under the directory in the distributed system, generate the update information for the directory according to operation information of the concurrent operations on the subdirectories, where the concurrent operations represent operations that are triggered in a same time period, and the operation information represents information generated by performing operations on the subdirectories.

In an embodiment, the concurrent increment module 512 includes:
a first concurrent increment submodule 5121, configured to enter a concurrent incremental state of the directory if it is determined that a number of times of concurrent operations of the subdirectories under the directory in the distributed system is greater than or equal to a second threshold and less than a third threshold, where the concurrent incremental state indicates that the update information for the directory is generated according to the operations, which are concurrent, on the subdirectories under the directory.

In an embodiment, the concurrent increment module 512 includes:
a second concurrent increment submodule 5122, configured to enter a second full incremental state of the directory if it is determined that the number of times of concurrent operations of the subdirectories under the directory in the distributed system is greater than or equal to a third threshold, where the second full incremental state indicates that the update information for the directory is generated according to concurrent operations on the subdirectories under the directory.

In an embodiment, the concurrent increment module 512 includes:
a concurrent increment exit submodule 5123, configured to exit the second full incremental state of the directory if no operations occur on the subdirectories in the directory for a third time period.

In an embodiment, the updating unit 520 includes:
a query module 521, configured to determine the update information corresponding to a same directory according to a primary key of the update information in the incremental table;
a merge module 522, configured to merge the update information for the same directory to obtain final information for the directory; and
an update module 523, configured to write the final information into the attribute file of the directory.

In an embodiment, the merge module 522 includes:
a first merge submodule 5221, configured to sum a numerical parameter in the update information to obtain the numerical parameter in the final information; and
a second merge submodule 5222, configured to iterate a non-numerical parameter in the update information according to a timestamp of the update information to obtain the non-numerical parameter in the final information.

In an embodiment, the attribute updating apparatus 500 further includes:
an instruction generation unit 530, configured to generate the merge instruction for the directory periodically according to a preset period of the directory; or, generate the merge instruction for the directory if it is detected that an amount of the update information corresponding to the directory in the incremental table is greater than or equal to a third threshold during traversing the incremental table in response to a user request.

The apparatus of this embodiment can implement the technical solution in the above method, and their specific implementation processes and technical principles are the same, which is not repeated here.

According to an embodiment of the present disclosure, the present disclosure also provides an electronic device, a readable storage medium and a computer program product.

According to an embodiment of the present disclosure, the present disclosure also provides a computer program product, which includes a computer program stored in a readable storage medium, from which at least one processor of an electronic device can read the computer program, and the at least one processor executes the computer program to enable the electronic device to execute the solution provided in any of the above embodiments.

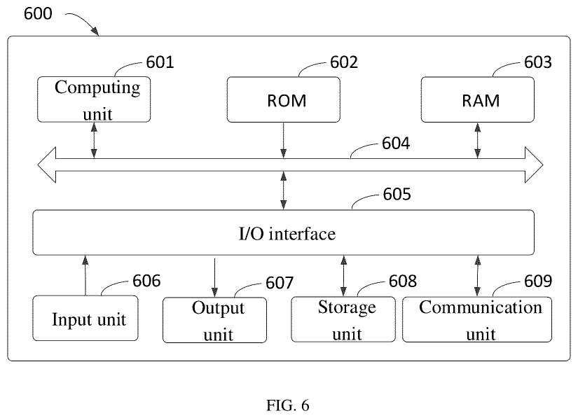

FIG. 6 shows a schematic block diagram of an electronic device 600 that can be used to implement an embodiment of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processing, cellular phones, smart phones, wearable devices and other similar computing devices. The components shown herein, connections and relationships thereof, and functions thereof are only examples, and are not intended to limit the implementation of the present disclosure described and/or claimed herein.

As shown in FIG. 6, the device 600 includes a computing unit 601, which can perform various appropriate actions and processes according to a computer program stored in a read-only memory (ROM) 602 or a computer program loaded from a storage unit 608 into a random access memory (RAM) 603. In the RAM 603, various programs and data required for the operation of the device 600 can also be stored. The computing unit 601, ROM 602 and RAM 603 are connected to each other through a bus 604. An input/output (I/O) interface 605 is also connected to the bus 604.

A plurality of components in the device 600 are connected to the I/O interface 605, including an input unit 606, such as a keyboard, a mouse, etc.; an output unit 607, such as various types of displays, speakers, etc.; the storage unit 608, such as a magnetic disk, an optical disk, etc.; and a communication unit 609, such as a network card, a modem, a wireless communication transceiver, etc. The communication unit 609 allows the device 600 to exchange information/data with other devices through a computer network such as the Internet and/or various telecommunication networks.

The computing unit 601 may be various general-purpose and/or special-purpose processing components with processing and computing capabilities. Some examples of the computing unit 601 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 601 performs various methods and processes described above, such as an attribute updating method for a directory in a distributed file system. For example, in some embodiments, the attribute updating method for the directory in the distributed file system can be implemented as a computer software program tangibly embodied in a machine-readable medium, such as the storage unit 608. In some embodiments, part or all of the computer program may be loaded and/or installed on the device 600 via the ROM 602 and/or the communication unit 609. When the computer program is loaded into the RAM 603 and executed by the computing unit 601, one or more steps of the attribute updating method for the directory in the distributed file system described above can be executed. Alternatively, in other embodiments, the computing unit 601 may be configured to perform an attribute updating method for a directory in a distributed file system by any other suitable means (for example, by means of firmware).

Various implementations of the systems and techniques described above herein may be implemented in digital electronic circuitry, integrated circuit systems, field programmable gate arrays (FPGA), application-specific integrated circuits (ASIC), application-specific standard products (ASSP), system-on-a-chip (SOC), complex programmable logic devices (CPLD), computer hardware, firmware, software, and/or combinations thereof. These various implementations may include being implemented in one or more computer programs that can be executed and/or interpreted on a programmable system including at least one programmable processor, which may be a special-purpose or general-purpose programmable processor and can receive data and instructions from a storage system, at least one input device, and at least one output device, and transmit data and instructions to the storage system, the at least one input device, and the at least one output device.

The program codes for implementing the method of the present disclosure can be written in any combination of one or more programming languages. These program codes may be provided to a processor or controller of a general-purpose computer, a special-purpose computer or other programmable data processing apparatus, so that the program codes, when executed by the processor or controller, cause the functions/operations specified in the flowcharts and/or block diagrams to be implemented. The program codes can be completely executed on a machine, partially executed on a machine, partially executed on a machine as a separate software package and partially executed on a remote machine, or completely executed on a remote machine or server.

In the context of this disclosure, a machine-readable medium may be a tangible medium, which may contain or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

In order to provide interaction with users, the systems and techniques described herein can be implemented on a computer having a display device (for example, a CRT (cathode ray tube) or an LCD (liquid crystal display) monitor) for displaying information to users; a keyboard and a pointing device (for example, a mouse or a trackball) through which a user can provide input to the computer. Other kinds of devices can also be used to provide interaction with users. For example, the feedback provided to the user can be any form of sensory feedback (for example, visual feedback, auditory feedback, or tactile feedback). And the input from the user can be received in any form (including acoustic input, voice input or tactile input).

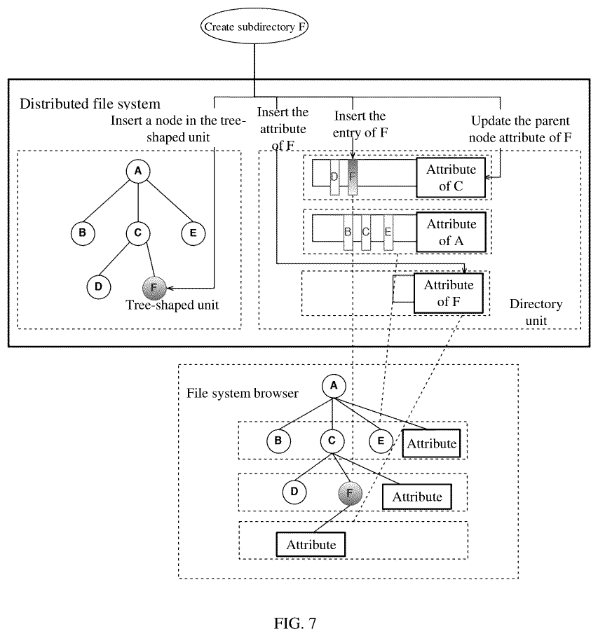

FIG. 7 is a scene diagram of a distributed file system where the embodiment of the present disclosure can be implemented. As shown in FIG. 7, the distributed file system can include two parts: a tree-shaped unit (Dtree) and a directory unit (Dentry). When a subdirectory F is required to be created under a directory C, a node of F is required to be inserted into the tree-shaped unit. And, it is required to update the attribute of F in the directory unit, and insert the interface of F in the parent node C of F and update the attribute of F's parent node. A view in the file system browser can also be included in FIG. 7.

The systems and techniques described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which a user can interact with embodiments of the systems and techniques described herein), or be implemented in a computing system including any combination of such back-end component, middleware component, or front-end component. Components of the system can be interconnected by any form or medium of digital data communication (for example, communication network). Examples of communication networks include local area network (LAN), wide area network (WAN) and the Internet.

A computer system may include a client and a server. The client and server are generally far away from each other and usually interact with each other through a communication network. The relationship between client and server is generated by computer programs running on corresponding computers and having a client-server relationship with each other. The server can be a cloud server, also known as a cloud computing server or a cloud host, and it is a host product in the cloud computing service system, so as to solve the shortcomings of traditional physical host and VPS service (“Virtual Private Server”, or “VPS” for short), which are difficult to manage and weak in business expansion. The server can also be a server of a distributed system or a server combined with a blockchain.

It should be understood that steps can be reordered, added or deleted using the various forms of flows shown above. For example, the steps described in this disclosure can be executed in parallel, sequentially or in different orders, so long as the desired results of the technical solution disclosed in this disclosure can be achieved, which is no restricted here.

The above specific embodiments do not limit the protection scope of this disclosure. It should be understood by those skilled in the art that various modifications, combinations, subcombinations and substitutions can be made according to design requirements and other factors. Any modification, equivalent substitution and improvement made within the spirit and principles of this disclosure should be included in the protection scope of this disclosure.

What is claimed is:

1. An attribute updating method for a directory in a distributed file system, comprising:
when it is determined that attribute information in an attribute file of the directory in the distributed file system needs to be updated, determining update information for the attribute file of the directory, and writing the update information into a preset incremental table; wherein, the distributed system comprises a plurality of directories, and the plurality of directories have a parent-child relationship; the update information indicates a modification content for the attribute file of the directory; and
updating the attribute file of the directory corresponding to the update information by using the update information in the preset incremental table in response to a merge instruction; wherein the merge instruction indicates to update the attribute file of the corresponding directory by using the update information in the preset incremental table.

2. The method according to claim 1, wherein the when it is determined that attribute information in an attribute file of the directory in the distributed system needs to be updated, determining update information for the attribute file of the directory comprises:
when it is determined that a conflict occurs in a read-write event of the attribute file of the directory in the distributed system, generating the update information for the directory according to operation information of a subdirectory that triggers the read-write event; wherein the read-write event indicates that the subdirectory requests to perform at least one of a reading operation and a writing operation on the attribute file; the operation information indicates information generated by performing an operation on the subdirectory.

3. The method according to claim 2, wherein the when it is determined that a conflict occurs in a read-write event of the attribute file of the directory in the distributed system, generating the update information for the directory according to operation information of a subdirectory that triggers the read-write event comprises:
entering a conflict incremental state of the directory if a number of conflict occurrences within a first time period is less than or equal to a first threshold, wherein the conflict incremental state indicates that the update information for the directory is generated according to operation information of a subdirectory corresponding to the read-write event in which a conflict occurs.

4. The method according to claim 2, wherein the when it is determined that a conflict occurs in a read-write event of the attribute file of the directory in the distributed system, generating the update information for the directory according to operation information of a subdirectory that triggers the read-write event comprises:
entering a first full incremental state of the directory if a number of conflict occurrences within a first time period is large than a first threshold, wherein the first full incremental state indicates that the update information for the directory is generated according to operation information of all subdirectories that trigger the read-write event of the attribute file.

5. The method according to claim 4, wherein the method further comprises:
exiting the first full incremental state of the directory if no read-write events occur on the attribute file of the directory within a second time period.

6. The method according to claim 1, wherein the when it is determined that attribute information in an attribute file of the directory in the distributed system needs to be updated, determining update information for the attribute file of the directory comprises:
when it is determined that there are concurrent operations on subdirectories under the directory in the distributed system, generating the update information for the directory according to operation information of the concurrent operations on the subdirectories, wherein the concurrent operations represent operations that are triggered in a same time period, and the operation information represents information generated by performing operations on the subdirectories.

7. The method according to claim 6, wherein the when it is determined that there are concurrent operations on subdirectories under the directory in the distributed system, generating the update information for the directory according to operation information of the concurrent operations on the subdirectories comprises:
entering a concurrent incremental state of the directory if it is determined that a number of times of concurrent operations on the subdirectories under the directory in the distributed system is greater than or equal to a second threshold and less than a third threshold, wherein the concurrent incremental state indicates that the update information for the directory is generated according to the operations, which are concurrent, on the subdirectories under the directory.

8. The method according to claim 6, wherein the when it is determined that there are concurrent operations on subdirectories under the directory in the distributed system, generating the update information for the directory according to operation information of the concurrent operations on the subdirectories comprises:
entering a second full incremental state of the directory if it is determined that a number of times of concurrent operations on the subdirectories under the directory in the distributed system is greater than or equal to a third threshold, wherein the second full incremental state indicates that the update information for the directory is generated according to the concurrent operations on the subdirectories under the directory.

9. The method according to claim 8, wherein the method further comprises:
exiting the second full incremental state of the directory if no operations occur on the subdirectories in the directory for a third time period.

10. The method according to claim 1, wherein the updating the attribute file of the directory corresponding to the update information by using the update information in the preset incremental table comprises:
determining the update information corresponding to a same directory according to a primary key of the update information in the incremental table;
merging the update information for the same directory to obtain final information for the directory; and
writing the final information into the attribute file of the directory.

11. The method according to claim 10, wherein the merging the update information for the same directory to obtain final information for the directory comprises:
summing a numerical parameter in the update information to obtain the numerical parameter in the final information;
iterating a non-numerical parameter in the update information according to a timestamp in the update information to obtain the non-numerical parameter in the final information.

12. The method according to claim 1, wherein the method further comprises:
generating the merge instruction for the directory periodically according to a preset period of the directory;
or,
generating the merge instruction for the directory if it is detected that an amount of the update information corresponding to the directory in the incremental table is greater than or equal to a third threshold during traversing the incremental table in response to a user request.

13. An electronic device comprising:
at least one processor; and
a memory communicatively connected to the at least one processor; wherein,
the memory stores instructions executable by the at least one processor, and the instructions are executed by the at least one processor to enable the at least one processor to implement the following steps:
when it is determined that attribute information in an attribute file of a directory in a distributed file system needs to be updated, determining update information for the attribute file of the directory, and writing the update information into a preset incremental table; wherein, the distributed system comprises a plurality of directories, and the plurality of directories have a parent-child relationship; the update information indicates a modification content for the attribute file of the directory; and
updating the attribute file of the directory corresponding to the update information by using the update information in the preset incremental table in response to a merge instruction; wherein the merge instruction indicates to update the attribute file of the corresponding directory by using the update information in the preset incremental table.

14. The electronic device according to claim 13, wherein the at least one processor is enabled to implement the following steps:
when it is determined that a conflict occurs in a read-write event of the attribute file of the directory in the distributed system, generating the update information for the directory according to operation information of a subdirectory that triggers the read-write event; wherein the read-write event indicates that the subdirectory requests to perform at least one of a reading operation and a writing operation on the attribute file; the operation information indicates information generated by performing an operation on the subdirectory.

15. The electronic device according to claim 14, wherein the at least one processor is enabled to implement the following steps:
entering a conflict incremental state of the directory if a number of conflict occurrences within a first time period is less than or equal to a first threshold, wherein the conflict incremental state indicates that the update information for the directory is generated according to operation information of a subdirectory corresponding to the read-write event in which a conflict occurs.

16. The electronic device according to claim 14, wherein the at least one processor is enabled to implement the following steps:
entering a first full incremental state of the directory if a number of conflict occurrences within a first time period is large than a first threshold, wherein the first full incremental state indicates that the update information for the directory is generated according to operation information of all subdirectories that trigger the read-write event of the attribute file.

17. A non-transitory computer-readable storage medium storing computer instructions, wherein the computer instructions are used to cause a computer to perform the following steps:
when it is determined that attribute information in an attribute file of a directory in a distributed file system needs to be updated, determining update information for the attribute file of the directory, and writing the update information into a preset incremental table; wherein, the distributed system comprises a plurality of directories, and the plurality of directories have a parent-child relationship; the update information indicates a modification content for the attribute file of the directory; and
updating the attribute file of the directory corresponding to the update information by using the update information in the preset incremental table in response to a merge instruction; wherein the merge instruction indicates to update the attribute file of the corresponding directory by using the update information in the preset incremental table.

18. The computer-readable storage medium according to claim 17, wherein the computer instructions are used to cause the computer to perform the following steps:
when it is determined that a conflict occurs in a read-write event of the attribute file of the directory in the distributed system, generating the update information for the directory according to operation information of a subdirectory that triggers the read-write event; wherein the read-write event indicates that the subdirectory requests to perform at least one of a reading operation and a writing operation on the attribute file; the operation information indicates information generated by performing an operation on the subdirectory.

19. The computer-readable storage medium according to claim 18, wherein the computer instructions are used to cause the computer to perform the following steps:
entering a conflict incremental state of the directory if a number of conflict occurrences within a first time period is less than or equal to a first threshold, wherein the conflict incremental state indicates that the update information for the directory is generated according to operation information of a subdirectory corresponding to the read-write event in which a conflict occurs.

20. The computer-readable storage medium according to claim 18, wherein the computer instructions are used to cause the computer to perform the following steps:
entering a first full incremental state of the directory if a number of conflict occurrences within a first time period is large than a first threshold, wherein the first full incremental state indicates that the update information for the directory is generated according to operation information of all subdirectories that trigger the read-write event of the attribute file.
